(19) United States
(12) Patent Application Publication
(10) Pub. No.: US 2018/0327042 A1
(43) Pub. Date: Nov. 15, 2018

(54) YOGA MAT LOCKER FOR A BICYCLE

(71) Applicant: Martha Louise Callaghan, Philadelphia, PA (US)

(72) Inventor: Martha Louise Callaghan, Philadelphia, PA (US)

(21) Appl. No.: 15/975,173

(22) Filed: May 9, 2018

Related U.S. Application Data
(60) Provisional application No. 62/503,413, filed on May 9, 2017.

(51) Int. Cl. B62J 9/00

(52) U.S. Cl. CPC B62J 9/003

(57) ABSTRACT

A yoga mat locker for a bicycle. The bicycle yoga mat locker includes a housing having a top end, a bottom end, a sidewall therebetween, and an opening leading into an interior volume. The interior volume defines a shape to store a rolled yoga mat. A lid covers and uncovers the opening of the housing. A locking mechanism is configured to lock the lid to the housing when the lid is covering the opening. A fastener protrudes from the sidewall of the housing and is configured to the housing to a bicycle frame.

### CROSS-REFERENCE TO RELATED APPLICATION

This application claims the benefit of priority of U.S. provisional application No. 62/503,413, filed May 9, 2017, the contents of which are herein incorporated by reference.

### BACKGROUND OF THE INVENTION

The present invention relates to storing yoga mats on a bicycle, in a bicycle yoga mat locker so that a yoga mat may be locked on an unattended bicycle, providing security, storage, and transportation for the yoga mat.

Yoga mats are specially fabricated mats used as an aid during the practice of yoga to provide floor padding and a clean space on which to practice yoga. Group yoga sessions commonly take place at gyms or studios. Typically, yogis take their own mats to yoga sessions. Sometimes yogis use bicycles as transportation. Bicycles currently lack a means to contain and then lock up the yoga mat while the bicycle is unattended. Because there is currently no means to lock up the yoga mat on a bicycle, the bicycle riding yogi is forced to carry the yoga mat wherever they go outside of the yoga studio; which can cause increased stress, physical and mental fatigue, as well as lower back pain.

As can be seen, there is a need for a bicycle yoga mat locker so that a yoga mat may be locked in the bicycle yoga mat locker on an unattended bicycle, providing security, storage, and transportation for the yoga mat.

### SUMMARY OF THE INVENTION

In one aspect of the present invention, a yoga mat locker for a bicycle comprises: a housing comprising a top end, a bottom end, a sidewall therebetween, and an opening leading into an interior volume, wherein the interior volume defines a shape to store a rolled yoga mat; a lid operable to cover and uncover the opening of the housing; a locking mechanism configured to lock the lid to the housing when the lid is covering the opening; and a fastener protruding from the sidewall of the housing and configured to couple the housing to a bicycle frame.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use;

FIG. 2 is a top perspective view of an embodiment of the present invention;

FIG. 3 is a bottom perspective view of an embodiment of the present invention;

FIG. 4 is a bottom exploded view of an embodiment of the present invention;

FIG. 5 is a section detail view taken along line 5-5 in FIG. 2;

FIG. 6 is a perspective view of an embodiment of the present invention; and

FIG. 7 is a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

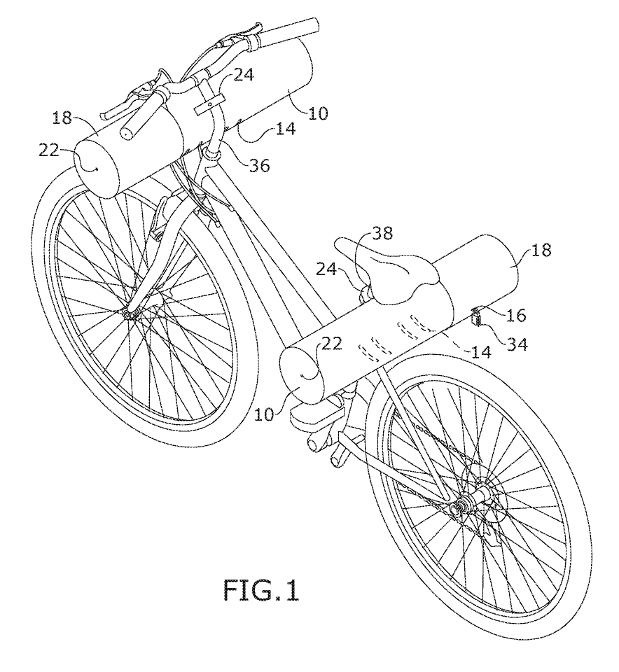

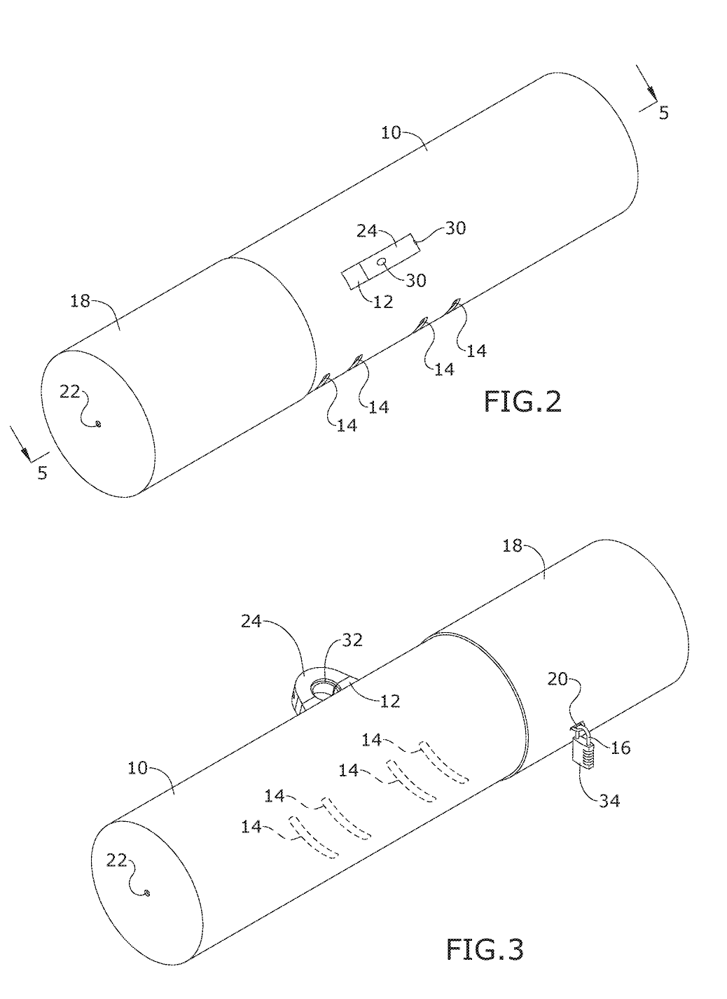

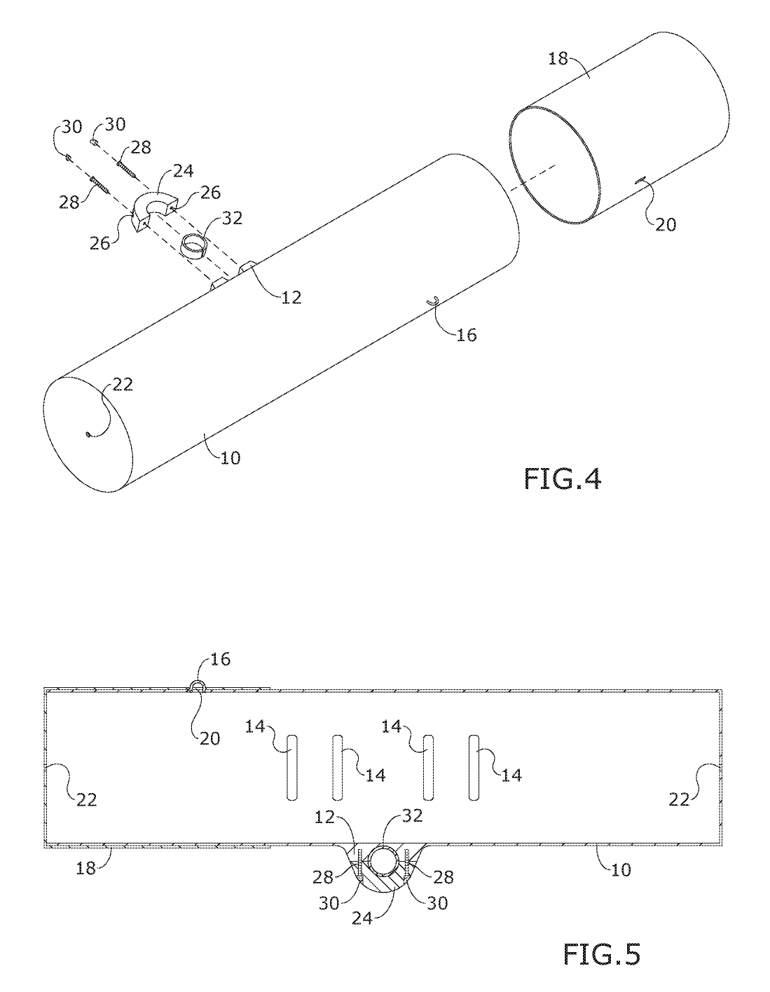

Referring to FIGS. 1 through 7, the present invention includes a yoga mat locker for a bicycle. The yoga mat locker includes a housing 10, 40 having a top end, a bottom end, a sidewall therebetween, and an opening leading into an interior volume. The interior volume defines a shape to store a rolled yoga mat. A lid 18, 42 covers and uncovers the opening of the housing 10, 40. A locking mechanism 16, 20, 48, 50, 34 is configured to lock the lid 18, 42 to the housing 10, 40 when the lid 18, 42 is covering the opening. A fastener 24, 12 protrudes from the sidewall of the housing 10, 40 and is configured to couple the housing 10, 40 to a bicycle frame.

As illustrated in the Figures, the housing 10, 40 is cylinder shape and therefore the interior volume defines a cylinder. The housing 10, 40 can be constructed using plastic, metal, rubber, and other suitable materials. In some embodiments, the materials are derived from recycled goods. In one embodiment, the housing 10, 40 measures approximately 26″ in length, 6″ in diameter, and 17″ in circumference. However, exact size, measurement, construction, and design specifications may vary upon manufacturing. In another embodiment, the housing 10, 40 is reinforced with a durable material along the length of the sidewall that communicates with the bicycle. In some embodiments, the housing 10, 40 is reinforced with a rod or rigid plastic strap that is affixed to the sidewall of the housing 10, 40 and runs the entire length of the sidewall. The reinforcement of the housing 10, 40 minimizes wear and tear on the housing 10, 40 from contact with the bicycle and the weight of the yoga mat.

The fastener 24, 12 may include bolts, vice grips, clamps, tubular webbing, rubber straps and the like (possibly secured to the bicycle with exterior, interior, or recessed hardware; or the TORX wrench method). The fastener 24, 12 may permanently affix the housing 10, 40 to the bicycle frame. As illustrated in the Figures, the fastener 24, 12 may include a clamp. The clamp may include a clamp foot 12 protruding from the sidewall of the housing 10 and having a first C-shaped inner edge. The clamp may further include a clamp cap 24 having a second C-shaped inner edge. The clamp foot 12 and the clamp cap 24 may fit together and include aligned openings. Bolts 38 may run through the aligned openings, fastening the clamp cap 24 to the clamp foot 12. Plugs 30 may fit within the ends of the openings of the clamp cap 24, covering the bolts 38. The clamp cap 24 and the clamp foot 12 may be clamped to the handlebar post 36 or the seat post 38 of the bicycle. A rubber gasket(s) 32 may line the C-shaped inner edges and thereby are looped around the posts 36, 38.

Referring to FIGS. 2 through 5, the housing 10 includes a top end that defines an opening and a bottom end that is closed. In such embodiments, the lid 18 includes an open bottom end, a closed top end, and a lid sidewall therebetween. The lid 18 is affixed over the top end of the housing 10 by a frictional fit between the lid sidewall and the sidewall of the housing 10. In such embodiments, the locking mechanism 16, 20 includes an elongated slot 20 disposed in the lid sidewall configured to receive a protrusion 16 disposed on the sidewall of the housing 10 therethrough. Once the lid 18 is affixed to the housing 10 and the protrusion 16 on the sidewall of the housing 10 is inserted into the elongated slot 20 in the lid sidewall, a user of the bicycle yoga mat locker can lock the lid 18 in place, securing the contents within the interior volume of the housing 10, by placing a padlock 34 through an aperture in the protrusion 16.

In certain embodiments, an air vent 22 is disposed on the closed top end of the lid 18. In some embodiments air vents are disposed on the closed bottom of the housing 10 and the closed top end of the lid 18. These air vents 22 allow for pressure equalization between the interior volume and the atmosphere, ensuring the lid 18 is tightly fitted to the housing 10. Additionally, a plurality of air slots 14 are disposed on the sidewall of the housing 10 to help prevent mildew buildup on stored yoga mats.

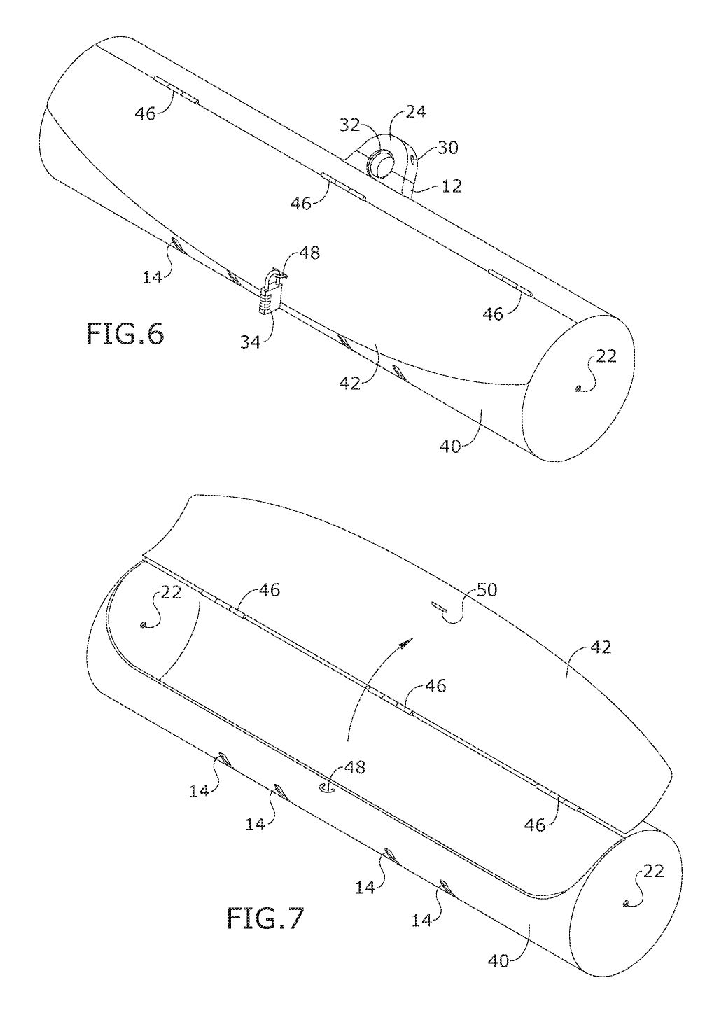

Referring to FIGS. 6 and 7, a housing 40 of the present invention may include an elongated opening disposed on the sidewall. In such embodiments, an elongated lid 42 is connected to the sidewall by hinges 46. The elongated lid 42 may include a slot 50 configured to receive a protrusion 48 disposed on the sidewall of the housing 40 therethrough. The elongated lid 42 is locked in a closed position by a padlock 34 disposed through an aperture in the protrusion 48. Alternatively, the housing 40 may be manufactured with a built-in combination lock.

It should be understood, of course, that the foregoing relates to exemplary embodiments of the invention and that modifications may be made without departing from the spirit and scope of the invention as set forth in the following claims.

What is claimed is:

1. A yoga mat locker for a bicycle comprising:
a housing comprising a top end, a bottom end, a sidewall therebetween, and an opening leading into an interior volume, wherein the interior volume defines a shape to store a rolled yoga mat;
a lid operable to cover and uncover the opening of the housing;
a locking mechanism configured to lock the lid to the housing when the lid is covering the opening; and
a fastener protruding from the sidewall of the housing and configured to couple the housing to a bicycle frame.

2. The yoga mat of claim 1, wherein the shape is a cylinder.

3. The yoga mat of claim 1, wherein the top end defines the opening and the bottom end is closed, wherein the lid comprises an open bottom end, a closed top end, and a lid sidewall therebetween, wherein the lid is affixed over the top end of the housing by a frictional fit between the lid sidewall and the sidewall of the housing.

4. The yoga mat of claim 3, wherein the locking mechanism comprises:
a protrusion disposed on the sidewall of the housing and comprising an aperture therethrough; and
a slot formed through the lid sidewall;
the protrusion fits through the slot when the lid is affixed to the housing.

5. The yoga mat of claim 1, wherein an air vent is disposed on the closed top end of the lid.

6. The yoga mat of claim 1, wherein a plurality of air slots are disposed on the sidewall of the housing.

7. The yoga mat of claim 1, wherein the fastener comprises a clamp.

8. The yoga mat of claim 7, wherein the clamp comprises:
a clamp foot protruding from the sidewall and comprising a first C-shaped inner edge;
a clamp cap comprising a second C-shaped inner edge; and
bolts fastening the clamp cap to the clamp foot.

9. The yoga mat of claim 8, further comprising a rubber gasket lining the first C-shaped inner edge and the second C-shaped inner edge.

10. The yoga mat of claim 1, wherein the opening is an elongated opening disposed on the sidewall and the lid is an elongated lid connected to the sidewall by hinges.
